(19) United States
(12) Patent Application Publication
(10) Pub. No.: US 2015/0034007 A1
(43) Pub. Date: Feb. 5, 2015

(54) COMPACT APPARATUS FOR PRODUCING A THREE-DIMENSIONAL OBJECT BY HARDENING A PHOTOCURING MATERIAL

(71) Applicant: tangible engineering GmbH, Stuttgart (DE)

(72) Inventors: Tim Fischer, Ostfildern (DE); Sebastian Kummler, Erdmannshausen (DE)

(21) Appl. No.: 14/445,318

(22) Filed: Jul. 29, 2014

(30) Foreign Application Priority Data
Jul. 31, 2013 (DE) 10 2013 215 040.7

(51) Int. Cl. B05C 9/12

(52) U.S. Cl. CPC B05C 9/12
USPC 118/620

(57) ABSTRACT

An apparatus for producing a three-dimensional object by hardening a photocuring material includes a radiation source unit having a radiation source for emitting light, a receiving device having a receiving surface for receiving the photocuring material in liquid form, a carrier plate for receiving the photocuring material in a cured form, said carrier plate being movable relative to the receiving device, and a deflection device for deflecting the light emerging from the radiation source onto the carrier plate. The deflection device has at least one totally reflecting optical element, wherein the light emerging from the radiation source unit is totally reflected at least twice overall by the at least one optical element. A compact configuration of the apparatus can be achieved as a result.

### CROSS-REFERENCE TO RELATED APPLICATIONS

This application claims priority to German Patent Application No. DE 10 2013 215 040.7, filed Jul. 31, 2013, the entire contents of which are hereby incorporated by reference.

### DESCRIPTION

### Field of the Invention

The invention relates to an apparatus for producing a three-dimensional object by hardening a photocuring material (stereolithography apparatus), comprising a radiation source unit comprising a radiation source for emitting light, a receiving device comprising a receiving surface for receiving the photocuring material in liquid form, a carrier plate for receiving the cured material, said carrier plate being movable relative to the receiving device, and comprising a deflection device for deflecting the light emerging from the radiation source onto the carrier plate.

### Background of the Invention

Stereolithography is a method in which three-dimensional objects are produced from thin layers. For this purpose, a thin layer of a photocuring liquid material is cured (polymerized) on the carrier plate by an intensive light source having an appropriate wavelength. After the curing of the layer, the carrier plate is moved by a layer thickness, such that the cured layer is coated with a thin film of liquid and the portions of the second film of liquid can be cured. A three-dimensional object can be produced in this way.

The photocuring material can be irradiated from above (top-down arrangement). After the curing of a layer, the carrier plate is then moved downward by a layer thickness. What is disadvantageous about this arrangement is that the polymerization trough (receiving device) for the liquid photocuring material must be at least as high as the object to be produced itself, which can be regarded as “dead” capital and which generally only has a service life of 6 months.

EP 0 484 086 A1 describes a bottom-up arrangement, in which the photocuring material is irradiated from the bottom. The carrier plate with the cured layers is in this case moved upwards out of the polymerization trough, such that the polymerization trough can be formed with a lower edge (compared with a top-down arrangement), and photocuring material can be saved. What is problematic, however, is that, in the case of illumination from the bottom, the cured material adheres not only to the carrier plate but also to the bottom of the trough. In order to reduce the adhesion of the cured material to the film, the bottom of the trough is covered with a semipermeable film, an inhibitor being fed into the cavity between the film and the bottom of the trough, such that an inhibitor layer is formed on that side of the film which faces away from the bottom of the trough. In order to detach the cured layers connected to the film by a residual adhesion, the carrier plate is displaced laterally via a depression. What is disadvantageous about this is that a very wide receiving apparatus has to be provided in order to enable the carrier plate to be displaced laterally.

A more compact bottom-up arrangement is known from EP 1 250 997 A1. In order to carry out the exposure from the bottom, the light source is arranged in a housing below the polymerization trough. The light emitted by the light source is directed onto the underside of the polymerization trough by means of a deflection mirror. In order to detach the cured material from the bottom of the polymerization trough, the polymerization trough disclosed in EP 1 250 997 A1 is lined with an elastic layer (silicone layer) to which the cured material adheres to a lesser extent than to the carrier plate. When producing relatively large objects, however, this does not suffice to ensure non-destructive detachment. Moreover, the housing in which the light is deflected takes up a relatively large amount of space since the light path (path between light source and polymerization trough) for a sharp imaging of the area to be illuminated onto the carrier plate or onto the underside of the polymerization trough must have a minimum length dependent on the size of the area to be illuminated. The apparatus known from EP 1 250 997 A1 is therefore more suited to objects having a small basic area (e.g. teeth/dental braces). Furthermore, the arrangement itself is larger than the printing region by a multiple. Arrangements known from the prior art which produce 3D objects having a size of 267 mm×165 mm×203 mm using the stereolithography method have dimensions of e.g. 122 cm×175 cm×152 cm (EnvisionTec ULT-RA2).

Accordingly, there is a need for a better design and method. The present invention fulfills these needs and provides other related advantages.

### SUMMARY OF THE INVENTION

Therefore, it is an object of the invention to reduce the ratio between the dimensions of an apparatus for stereolithography and the usable printing region in a simple manner compared with the known apparatuses.

This object is achieved according to the invention by virtue of the fact that the deflection device has at least one totally reflecting optical element, wherein the light emerging from the radiation source unit is totally reflected at least twice overall by the at least one optical element.

The provision of a plurality of total reflections (for a respective light ray) means that the deflection device can be made compact while maintaining the light path required for a high-quality imaging. The optical deflection device according to the invention can comprise a plurality of optical elements which each bring about one total reflection, e.g. mirrors, in particular surface mirrors or concave mirrors, or at least one optical element which brings about a multiple total reflection, e.g. light guiding elements, in particular optical fibres, optical wedges (cf. Travis “Wedge Optics in Flat Panel Displays”), structured light guiding elements.

The term “photocuring material” denotes materials which cure under the action of light. Depending on the material, light having a specific wavelength is required for this purpose. The radiation source unit is accordingly coordinated with the photocuring material to be used. As a result of the irradiation of the carrier plate, the photocuring material present at the irradiated locations is cured and adheres to the underside of the carrier plate.

Preferably, the radiation source unit is configured as a projection arrangement that projects light onto the carrier plate in accordance with the cross section of a layer of the object to be produced, in particular a digital mirror device projector, an LCD-based projector or a laser projector.

The movable carrier plate enables the positioning of the object to be formed relative to the receiving device. Vertical movement of the carrier plate within the receiving device or out of the receiving device brings about a wetting of an already cured layer with liquid photocuring material.

The apparatus according to the invention can be embodied as a bottom-up apparatus or as a top-down apparatus. In the case of a bottom-up apparatus, at least one part of the receiving device is light-transmissive, at least in the wavelength range required for the curing of the photocuring material. The receiving device can be designed to be separable or removable from a feed apparatus for fluids. Sealing elements are typically provided for this purpose.

In one particularly preferred embodiment of the invention, the deflection device and the radiation source unit are arranged such that the direction of emergence of the light emerging from the radiation source unit is opposite to the direction of incidence with which the light impinges on the carrier plate.

Preferably, the axes (central ray) of the divergent beams of the light emerging from the radiation source and of the light impinging on the carrier plate are parallel to one another. According to the invention, however, an “opposite direction” of the light emerging from the radiation source and of the light impinging on the carrier plate is given even if at least one light ray leaves the light source in a direction opposite to the direction of incidence (of said light ray) on the carrier plate. The deflection device therefore brings about a deflection of the light by approximately 180°. The inventive arrangement of the radiation source with the direction of emergence of the light opposite to the direction of incidence on the carrier plate enables a particularly compact configuration of the apparatus.

In one preferred embodiment of the invention, the radiation source unit is arranged alongside the receiving device. The receiving device and the radiation source unit are then in other words offset horizontally relative to one another. As a result, less structural space is required, in particular below the apparatus or in a depth direction of the apparatus.

In one particularly preferred embodiment of the apparatus according to the invention, the deflection device comprises optical elements mounted in a movable fashion. By way of example, mirrors can be embodied in a pivotable fashion, such that they can be folded away when the apparatus is not in operation. The space can then be used for a different purpose, e.g. for receiving of items.

One development of this embodiment provides for a turntable for receiving an object to be scanned or a mount for the turntable and/or at least one light-sensitive sensor for recording the object arranged on the turntable to be provided at least partly within the deflection device. In this way—if e.g. a mirror is folded away—an object to be scanned can be positioned completely within or at least partly within the deflection device on the turntable, such that the apparatus can also be used as a 3D scanner, 3D fax or as a postcure device. The apparatus is then advantageously configured in such a way that further functional units can be integrated into the deflection device without further space requirement. For completely or at least partly introducing the object into the deflection device, the turntable and/or the mount for the turntable can be moved from a set-up position arranged outside the deflection device, for example, into a scanning position arranged completely within or at least partly within the deflection device. In order to remove the scanned object after the scanning process, the turntable for example together with the scanned object can be moved again from the scanning position into the set-up or removal position and can be removed there. The light-sensitive sensor for recording (an image of) the object to be scanned can be embodied for example as a camera, as a sensor array or as a so-called time-of-flight sensor. For faxing an object, firstly the object is scanned and then the information about the three-dimensional form of the object (for example in the form of a grid or mesh) is transmitted (e.g. via the Internet) and, after the reception thereof, is printed again three-dimensionally.

Particularly for the production of large components, it is advantageous if a height adjusting device for vertically adjusting the carrier plate is provided, which provides guide elements on two opposite regions of the carrier plate. The dimension of the height adjusting device according to the invention along the movement direction can then be chosen such that it is only slightly larger than the stroke of the height adjusting device, as a result of which in turn a reduction of the dimensions of the apparatus is realized. Preferably, the guide elements are arranged centrally relative to the length of two opposite edges of the carrier plate. On account of the lateral, central guidance of the carrier plate, the apparatus can be used even for large, heavy objects, without risking a tilting of the carrier plate or having to provide a heavy and bulky reinforcement.

In one advantageous development of this embodiment, two actuators which can be operated in parallel are provided as guide elements. The actuators can be embodied as linear motors, are preferably synchronized and move the carrier plate translationally.

In one particularly preferred embodiment of the invention, the surface area of the receiving surface (bottom of the receiving device) is less than 200%, preferably less than 150%, in particular less than 135%, of the surface area of the underside of the carrier plate. The size of the underside of the carrier plate defines the maximum printing region. By virtue of the fact that the size of the receiving surface and the size of the carrier plate do not differ significantly, objects having a large cross section can be produced despite a compact apparatus.

In order to facilitate the detachment of the cured material from the film, it is advantageous if the receiving device comprises a semipermeable film spanned over the receiving surface, wherein a cavity is provided between the receiving surface and the semipermeable film, said cavity being connected to a feed apparatus serving for feeding liquid or gaseous substances into the cavity. The semipermeable film is impermeable to the photocuring material but permeable to the liquid or gaseous substances to be fed. The semipermeable film can be embodied for example as a transparent FEP (fluorinated ethylene propylene) film. These substances serve as inhibitors for the polymerization, in order to prevent polymerization at the contact area of the film. In the preferred embodiment, the inhibitors in the case of acrylic-based resins are oxygen or atmospheric air. In this case, there is no direct contact between the material to be hardened and the receiving surface. The liquid or gaseous substance is pumped into the cavity at atmospheric pressure or at slight excess pressure, preferably continuously. In order that an overly high excess pressure does not arise, an outlet for the respective medium is provided.

In order to enable detachment of the cured material from the carrier plate without translational movement, the photocuring material preferably has a viscosity of less than 100 mPa·s (100cP) in the liquid state at room temperature. The use of a photocuring material having low viscosity and/or low surface tension means that objects having a large basic area can be detached from the film and made to adhere to the carrier platform, without having to carry out a sideways movement of the carrier plate via a recess in the receiving apparatus (as is necessary e.g. in the case of the method known from EP 0 484 086 A1). In this way, the carrier plate can be embodied with a size similar to that of the receiving device. Furthermore, the use of a low viscosity and/or a low surface tension makes it possible to increase the printing precision of the apparatus (that is to say decrease the “minimal feature size”) and to increase the printing speed. In this regard, e.g. with a viscosity of 25 mPa·s (25cP) at 20° C. and a surface tension of 33.5 dyn/cm (33.5 mN/m), the residual adhesion between the photocuring material and the semipermeable film can be kept so low that workpiece structures having an area of only 0.0747 mm2 and a layer height of 0.1 mm can be detached non-destructively.

Preferably, the receiving device and/or the feed apparatus comprises a discharge preventer for the photocuring material situated therein. In this regard, for example, by using a PTFE membrane at the respective cavities of the feed apparatus, it is possible to prevent the photosensitive material from being discharged in the event of damage to the film.

Furthermore, it is advantageous if a calibration apparatus for calibrating the vertical position of the carrier plate is provided. A precise distance between the carrier plate and the film can be set with the aid of the calibration apparatus. Said distance serves firstly as a safety distance, in order that the carrier plate cannot damage the film, and secondly as predefinition for the first layer height. The calibration apparatus can comprise, for example, a self-adhesive aluminium film or similarly conductive materials arranged on a region of the film situated opposite the carrier plate. As a result of a contact of the carrier plate (the latter is preferably electrically conductive) with the film, the distance for the first layer height can thus be established electrically.

The apparatus according to the invention is particularly advantageous if an integrated control unit is provided for independently creating objects, in particular on the basis of preprocessed object data or on the basis of original CAD data, STL (surface tessellation language) files or point clouds, which are transmitted by means of data carriers or via the network. With the use of original CAD data, the latter can be processed directly on the internal control unit of the overall apparatus. In this way, the apparatus according to the invention operates independently without a further external data processing unit (e.g. a PC) and with a high processing speed. Preprocessing steps of 3D models can also be realized independently and rapidly in this way. Overall, the apparatus according to the invention thus operates in a more space-saving manner.

Preferably, the integrated control unit comprises a graphics processing unit (GPU) that is used for the preprocessing of original CAD data, STL files or point clouds (“slicing”). This is advantageous, in particular, if the apparatus is used in combination with a scanner. The (printing) preprocessing can be carried out in the manner described below. One or more three-dimensional models (for example data about the three-dimensional form of an object on the basis of grid points, “mesh”) can be loaded from the files (CAD, STL) into a memory of the control unit. In this case, a so-called “slicer” preferably operates by means of OpenGL. The coordinate system is generally chosen such that the Z-axis represents the height of the three-dimensional object to be produced. After the 3D meshes have been loaded into the memory of the graphics processing unit, a lower area of so-called mesh bounding boxes is assigned in each case to Z=0 and the X-Y coordinates of the midpoints of the 3D meshes are chosen such that the 3D meshes do not overlap.

Afterwards, the following algorithm can be applied to each layer beginning with the first layer (n=1): in order to determine the cross sections to be exposed of the object for the n-th layer, an OpenGL camera is then positioned at Z=n*(s/2) with viewing direction at X=Y=Z=0, wherein s is the layer height. A first pass of a so-called OpenGL scene rendering is then initiated, which renders only into a stencil buffer. In this case, two additional operations are defined: a) increment stencil buffer if a rear side of a polygon is rendered; b) decrement stencil buffer if a front side of a polygon is rendered. A further pass renders into the colour buffer only a white polygon onto those pixels in the image in which the stencil buffer is less than zero. The resulting image in the colour buffer then corresponds to the cross section to be exposed. While the cross-sectional images to be exposed are determined, the cross-sectional images can be hollowed out taking account of overlying and underlying views, in order to obtain hollow objects of a defined maximum wall thickness. Furthermore, support structures can be generated in an automated manner in a conventional way.

In one particularly preferred embodiment of the apparatus, the radiation source unit is embodied as a mask exposure unit. A more uniform and rapid illumination of the photocuring material is possible as a result. The region to be exposed corresponds to the cross section to be hardened of the photocuring material.

The teaching according to the invention makes it possible to realize stereolithography apparatuses having dimensions of the order of magnitude of 62 cm×60 cm×48 cm which have a printing region of e.g. 280 mm×210 mm×210 mm, standard components that can be procured in an expedient manner being used.

Further advantages of the invention are evident from the description and the drawing. The features mentioned above and those presented further can likewise be used in each case by themselves or as a plurality in arbitrary combinations. The embodiments shown and described should not be understood as an exhaustive enumeration, but rather are of exemplary character for portraying the invention.

### BRIEF DESCRIPTION OF THE DRAWINGS

The accompanying drawings illustrate the invention. In such drawings:

FIG. 1a shows one preferred embodiment of the apparatus according to the invention comprising a deflection device having two deflection mirrors and comprising a laterally guided carrier plate;

FIG. 1b shows a deflection device comprising a mirror and a prism for an alternative embodiment of the apparatus according to the invention;

FIG. 1c shows a deflection device comprising an optical wedge for a further alternative embodiment of the apparatus according to the invention;

FIG. 1d shows a deflection device comprising an optical wedge and a prism for a further alternative embodiment of the apparatus according to the invention;

FIG. 1e shows a deflection device comprising light guiding elements for a further alternative embodiment of the apparatus according to the invention;

FIG. 2 shows one particularly preferred embodiment of the apparatus according to the invention having an integrated scanner function; and

FIG. 3 shows one specific configuration of the receiving device of the apparatus according to the invention comprising a semipermeable film and a feed apparatus for fluids.

### DETAILED DESCRIPTION OF THE PREFERRED EMBODIMENTS

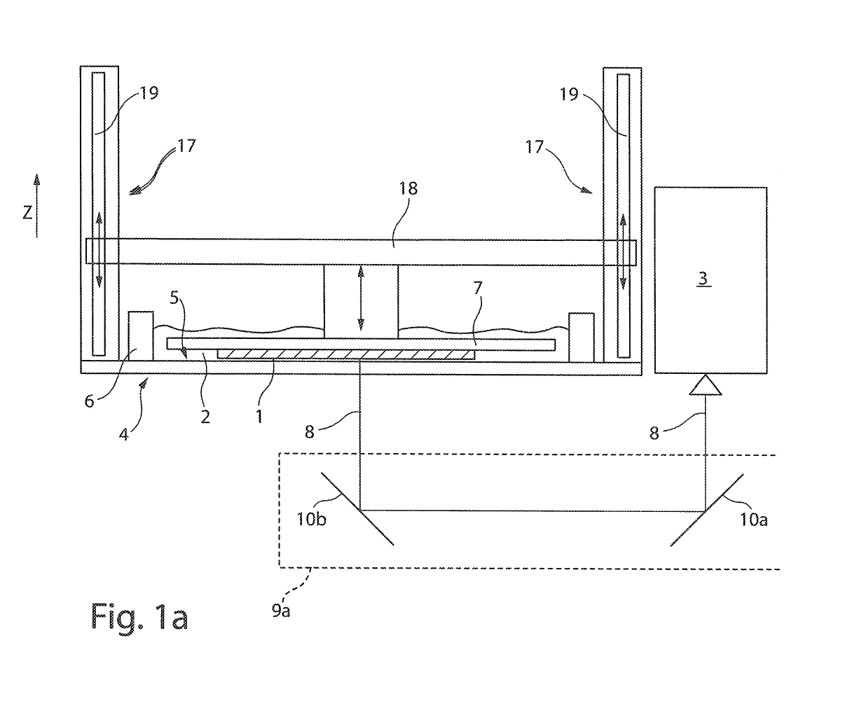

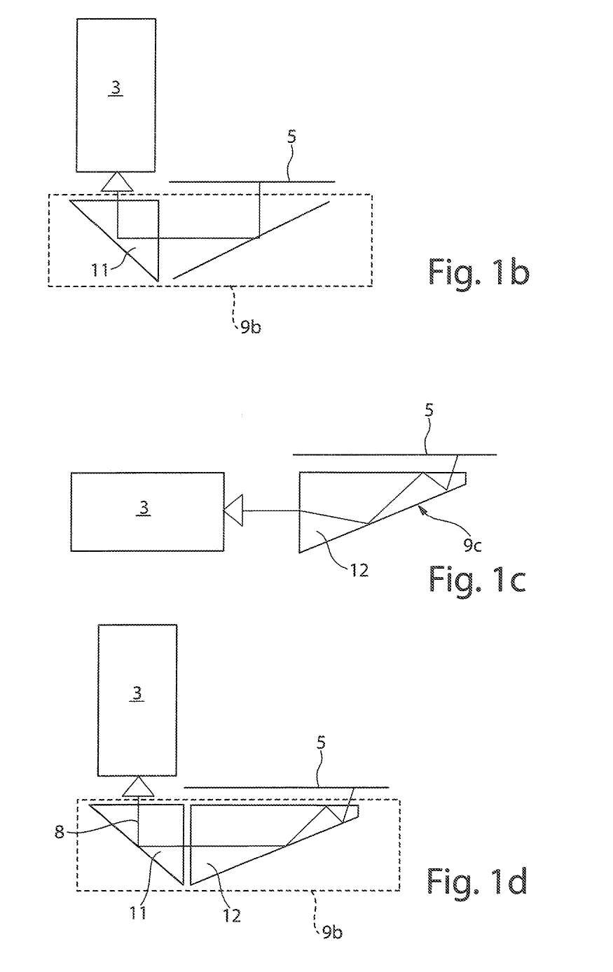

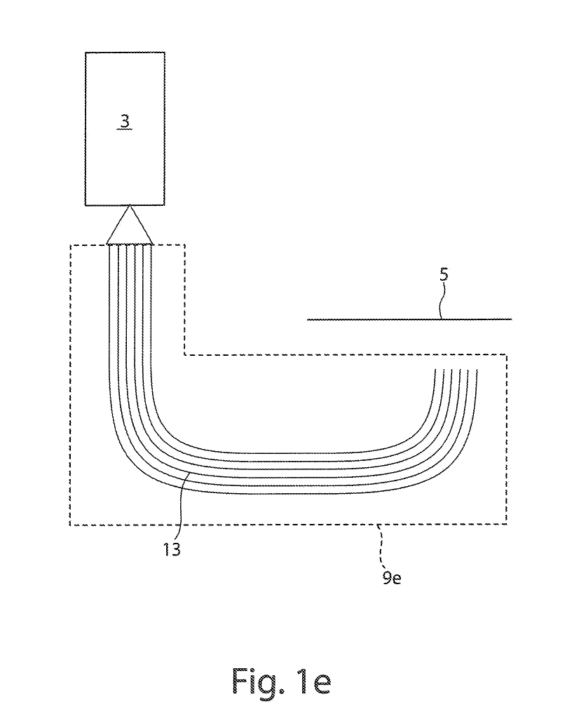

FIG. 1a shows an apparatus according to the invention for producing a three-dimensional object 1 by hardening a photocuring material 2 by light irradiation from a radiation source unit 3. A receiving device 4 is provided for receiving the liquid photocuring material 2. In the present case, the receiving device 4 is embodied as a trough having a receiving surface 5 and walls 6. A carrier plate 7, which is movable relative to the receiving device 4, projects into the liquid photocuring material 2 and is irradiated with light 8 at previously defined locations in order to bring about a curing of the photocuring material 2 at these locations. In one preferred embodiment, the carrier plate 7 can be formed from a porous plate having closed pores. By means of a deflection device 9a, the light 8 emerging from the radiation unit 3 is directed onto the carrier plate 7. The deflection device 9a has optical elements bringing about a plurality of total reflections (two in this case). In the example shown in FIG. 1a, the direction of propagation is reversed by means of two optical elements embodied as mirrors 10a, 10b. In the example shown, the light 8 emerging from the radiation unit 3 is totally reflected by an angle of 90° twice, such that the direction of emergence of the light emerging from the radiation source unit is opposite to the direction of incidence with which the light impinges on the carrier plate 7. As a result of the multiple reflection of the light 8, a predefined light path can be realized in a smaller space, which enables a more compact construction of the apparatus. In particular, the radiation source unit 3 can be arranged alongside the receiving device 4 (instead of below or above), as shown in FIG. 1a. The apparatus according to the invention is shown as a bottom-up arrangement in FIG. 1a, which is particularly advantageous with regard to the required amount of photocuring material; however, the compact configuration according to the invention on account of the multiple reflection of the light is also applicable to top-down arrangements.

In order to move the carrier plate 7 relative to the receiving device 4, a height adjusting device 17 is provided. The height adjusting device 17 comprises actuators 19, to which the carrier plate 7 is connected by means of a mount 18. The actuators 19 are oppositely arranged relative to the carrier plate 7 and move the latter in the z-direction. As a result of the lateral fitting of the actuators 19, this part of the arrangement according to the invention can also be made compact.

The apparatus can comprise a tank (not illustrated) for the photocuring material 2, from which the photocuring material 2 can be fed to the receiving device 4. This feeding can be fed in a regulated manner, for example by means of a liquid sensor and a valve. The position of the tank is preferably situated on the rear side of guide elements.

The apparatus can furthermore have a cover (not illustrated), for example a cover embodied as a hood. With the aid of the cover, firstly, the photocuring material 2 is protected against light incident from outside; secondly, the cover serves as safety protection. The cover is preferably fashioned such that it is transparent, but opaque to those wavelengths which harden the photocuring material 2.

FIGS. 1b-e show alternative deflection devices 9b, 9c, 9d, 9e which can be used to deflect the light 8 emerging from the radiation source 3. In this regard, e.g. the second mirror 10b from FIG. 1a can be replaced by a prism 11 (FIG. 1b). FIG. 1c shows a deflection device 9c in which the light is totally reflected multiply within an optical wedge 12. In the embodiment shown in FIG. 1d, the optical wedge 12 is combined with a prism 11, as a result of which, in contrast to the embodiment shown in FIG. 1c, a deflection of the light 8 by 180° is made possible (analogously to FIGS. 1a, b). The optical wedge 12, depending on type and position, can be combined with the prism 11 arranged in a suitable angular position for this purpose. The use of an optical wedge 12 enables the required structural space to be reduced further. Furthermore, it can be advantageous to use curved optical waveguide elements, in particular optical fibres 13, as shown in FIG. 1e. The optical waveguide elements 13 are led from the radiation source unit 3 to (or into the vicinity of) the carrier plate 7 (not illustrated in FIG. 1e). In all of the embodiments, further optical elements, e.g. lenses and diaphragms (not shown), can be provided in order to obtain the desired light distribution on the carrier plate.

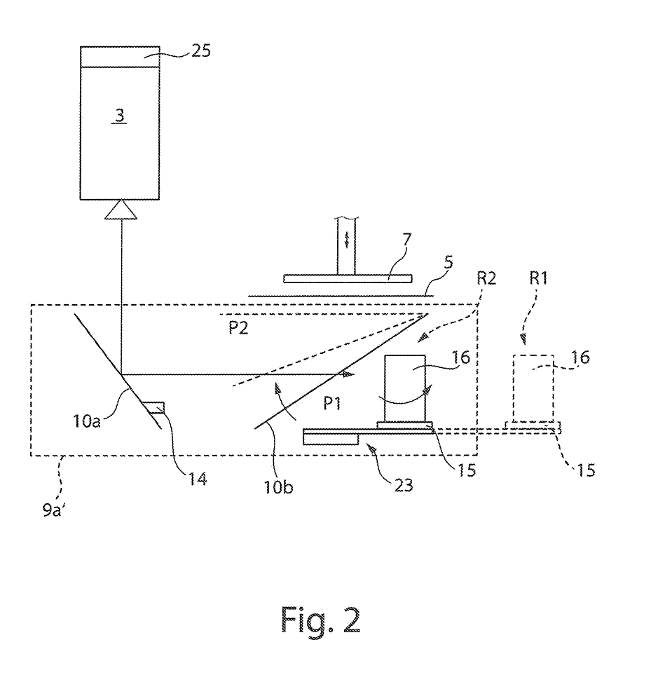

FIG. 2 shows one particularly preferred embodiment of the apparatus according to the invention comprising a deflection device 9a′. The deflection device 9a′ is embodied analogously to the deflection device 9a shown in FIG. 1a comprising two mirrors 10a, 10b, wherein the second mirror 10b is configured in a pivotable fashion and, as a result, can be pivoted from an operating position P1 into a parking position P2. Within the deflection device, in the example shown in FIG. 2, there are arranged a light-sensitive sensor embodied as a camera 14 and a turntable 15 mounted in a movable fashion on a mount 23, on which turntable an object 16 to be copied can be positioned if the second mirror 10b is situated in the parking position P2. In this way, the apparatus (3D printer) according to the invention can also be used as a scanner. In scanning operation (mirror 10b in parking position P2), the radiation source unit 3 (or an additional light source) is used to project structured light onto the object 16 to be copied that rotates on the turntable 15. The profile of the projected lines is picked up by the camera 14 and serves to determine the form of the object 16 to be copied. For completely or at least partly introducing the object 16 into the deflection device 9a′, the turntable 15 and/or the mount 23 for the turntable 15 can be moved from a set-up position R1 arranged outside the deflection device 9a′ into a scanning position R2 arranged completely within or at least partly within the deflection device 9a′. For printing operation, the object 16 to be copied is removed from the deflection device 9a′ and the second mirror 10b is pivoted into its operating position P1 again, such that the light 8 emerging from the radiation source unit 3 is again directed onto the receiving surface 5 and the carrier plate 7. For removing the scanned object 16, the turntable 15 together with the scanned object 16 can be moved again from the scanning position R2 into the set-up or removal position R1 and can be removed there.

For independently creating objects, an integrated control unit 25 is provided. In addition to the integrated control unit 25, an operating panel, for example a touch-sensitive screen, can be provided, which enables a user to interact with the apparatus without further external devices.

An optical code, e.g. in the form of a QR code or barcode, can furthermore be fitted on the receiving device 4, for example on the underside. This code can be identified by means of a light-sensitive sensor (for example the camera 14) and processed in the integrated control unit 25.

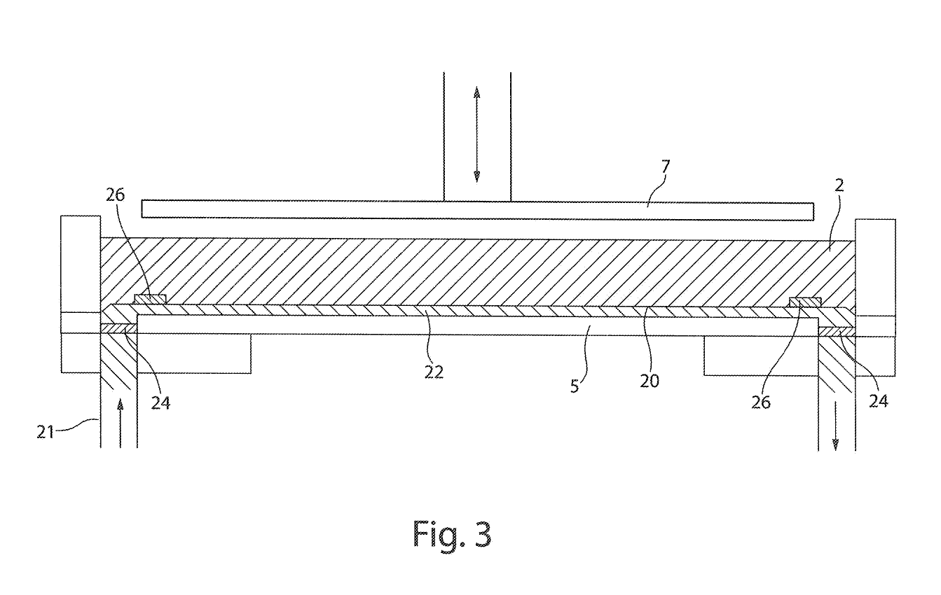

FIG. 3 shows one specific configuration of a receiving device for a bottom-up arrangement comprising a semipermeable film 20 and a feed apparatus 21 for fluids. The receiving device can be configured such that it is removable. The semipermeable film 20 is impermeable to the photocuring material 2 and is spanned over the receiving surface 5 such that a cavity 22 is formed between the film 20 and the receiving surface 5. Therefore, the photocuring material 2 does not come into direct contact with the receiving surface 5. By means of the feed apparatus 21, a fluid, e.g. air, is introduced into the cavity 20. Part of the fluid introduced into the cavity penetrates through the semipermeable film 20 and forms a fluid film (not shown) between the film 20 and the photocuring material 2. By the choice of a suitable viscosity and/or surface tension of the photocuring material 2 depending on the basic area of the object to be manufactured (the larger the object, the lower the viscosity or surface tension to be chosen), the cured material 2 can be detached from the film 20 merely by the movement of the carrier plate 7 in the z-direction (perpendicularly to the receiving surface), without the object or the film 20 being damaged. A calibration apparatus 26 is furthermore provided for the calibration of the vertical position of the carrier plate 7. A precise distance between the carrier plate 7 and the film 20 can be set with the aid of the calibration apparatus 26.

By means of the deflection apparatus according to the invention having multiple total reflections in particular in combination with the above-described lateral guidance of the carrier plate and the suitable choice of the viscosity and/or the surface tension of the photocuring material, a compact 3D printing apparatus can be realized with simple means.

Although several embodiments have been described in detail for purposes of illustration, various modifications may be made to each without departing from the scope and spirit of the invention. Accordingly, the invention is not to be limited, except as by the appended claims.

### LIST OF REFERENCE SIGNS

1 Object, cured form

2 Photocuring material (liquid)

3 Radiation source unit

4 Receiving device

5 Receiving surface (bottom of the receiving device)

6 Walls of the receiving device

7 Carrier plate

8 Light from radiation source unit

9a-d, 9a′ Deflection devices

10a, 10b Deflection mirrors

11 Prism

12 Optical wedge

13 Optical fibres

14 Camera

15 Turntable

16 Object to be copied

17 Height adjusting device

18 Mount of the height adjusting device

19 Actuators

20 Semipermeable film

21 Feed device

22 Cavity between film and receiving surface

23 Mount of the turntable

24 Discharge preventer

25 Control unit

26 Calibration apparatus

P1 Operating position of the pivotable mirror

P2 Parking position of the pivotable mirror

R1 Set-up or removal position of the object to be copied

R2 Scanning position of the object to be copied

What is claimed is:

1. An apparatus for producing a three-dimensional object by hardening a photocuring material, the apparatus comprising:
a radiation source unit configured to emit light;
a receiving device comprising a receiving surface configured to receive a photocuring material in a liquid form;
a carrier plate configured to receive the photocuring material in a cured form, said carrier plate being movable relative to the receiving device; and
a deflection device configured to deflect the light emerging from the radiation source unit onto the carrier plate, wherein the deflection device has at least one totally reflecting optical element, and wherein the light emerging from the radiation source unit is totally reflected at least twice overall by the at least one totally reflecting optical element.

2. The apparatus of claim 1, wherein the deflection device and the radiation source unit are arranged such that the direction of emergence of the light emerging from the radiation source unit is opposite to the direction of incidence with which the light impinges on the carrier plate.

3. The apparatus of claim 1, wherein the radiation source unit is arranged alongside the receiving device.

4. The apparatus of claim 1, wherein the deflection device comprises at least one movably mounted optical element.

5. The apparatus of claim 4, including a turntable for receiving an object to be scanned or a mount for the turntable and at least one light-sensitive sensor configured to record the object arranged on the turntable, where the at least one light-sensitive sensor is provided at least partly within the deflection device.

6. The apparatus of claim 1, including a height adjusting device configured to vertically adjust the carrier plate, the height adjusting device comprising guide elements on two opposite regions of the carrier plate.

7. The apparatus of claim 6, wherein the guide elements are two actuators which can be operated in parallel.

8. The apparatus of claim 6, including a calibration apparatus configured to calibrate a vertical position of the carrier plate.

9. The apparatus of claim 1, wherein a surface area of the receiving surface is less than 200% of a surface area of an underside of the carrier plate.

10. The apparatus of claim 1, wherein a surface area of the receiving surface is less than 150% of a surface area of an underside of the carrier plate.

11. The apparatus of claim 1, wherein the receiving device comprises a semipermeable film spanned over the receiving surface, wherein a cavity is provided between the receiving surface and the semipermeable film, said cavity being connected to a feed apparatus serving for feeding liquid or gaseous substances into the cavity.

12. The apparatus of claim 11, wherein the photocuring material in the liquid form has a viscosity of less than 100 mPa·s at room temperature.

13. The apparatus of claim 11, wherein the receiving device and/or the feed apparatus comprises a discharge preventer configured to prevent the discharge of the photocuring material situated therein.

14. The apparatus of claim 1, including an integrated control unit connected to the radiation source unit, the integrated control unit configured to independently creating objects, in particular on the basis of preprocessed object data or on the basis of original CAD data, STL files or point clouds.

15. The apparatus of claim 14, wherein the integrated control unit comprises a graphics processing unit (GPU) that is used for the preprocessing of original CAD data, STL files or point clouds (“slicing”).

16. The apparatus of claim 1, wherein the radiation source unit is a mask exposure unit.

17. An apparatus for producing a three-dimensional object by hardening a photocuring material, the apparatus comprising:
a radiation source unit configured to emit light;
a receiving device comprising a receiving surface configured to receive a photocuring material in a liquid form;
a carrier plate configured to receive the photocuring material in a cured form, said carrier plate being movable relative to the receiving device;
a deflection device configured to deflect the light emerging from the radiation source unit onto the carrier plate, wherein the deflection device has at least one totally reflecting optical element, and wherein the light emerging from the radiation source unit is totally reflected at least twice overall by the at least one totally reflecting optical element;
wherein the deflection device and the radiation source unit are arranged such that the direction of emergence of the light emerging from the radiation source unit is opposite to the direction of incidence with which the light impinges on the carrier plate;
wherein the radiation source unit is arranged alongside the receiving device; and
including a height adjusting device configured to vertically adjust the carrier plate, the height adjusting device comprising guide elements on two opposite regions of the carrier plate;
wherein a surface area of the receiving surface is less than 135% of a surface area of an underside of the carrier plate.
